(19) United States
(12) Patent Application Publication
(10) Pub. No.: US 2006/0163900 A1
(43) Pub. Date: Jul. 27, 2006

(54) Motorcycle fairing mounting bracket

(76) Inventor: Willem van der Hoeven, Seattle, WA (US)

Correspondence Address: WHITAKER LAW GROUP, 755 WINSLOW WAY EAST, SUITE 304, BAINBRIDGE ISLAND, WA, 98110, US

(21) Appl. No.: 11/335,930

(22) Filed: Jan. 20, 2006

Related U.S. Application Data
(60) Provisional application No. 60/645,901, filed on Jan. 21, 2005.

(51) Int. Cl. B62J 17/00

(52) U.S. Cl. 296/78.1

(57) ABSTRACT

Two fairing mounting brackets are attached on either side of the lower portion of a fairing assembly. The brackets engage the motorcycle at the upper portions of the fork assembly via an upper and lower docking post on each side of the motorcycle. The edges of the brackets serve as guide ramps that lead to upper and lower U shaped female docking points in the brackets During attachment, the brackets guide the fairing downward by sliding the guide ramps along the male docking posts on the motorcycle into a position where the upper and lower male docking posts fully engage the upper and lower female docking points of the brackets. A locking mechanism secures the brackets to the motorcycle when in the fully engaged position.

### CROSS REFERENCE TO RELATED APPLICATIONS

This application claims priority to co-pending U.S. Provisional Patent Application No. 60/645,901 filed Jan. 21, 2005 in the name of Willem van der Hoeven, entitled Easy Connect Motorcycle Fairing Brackets, which is hereby expressly incorporated by reference.

### BACKGROUND OF THE INVENTION

This invention relates to motorcycles and more particularly to mounting brackets for motorcycle fairings.

The use of motorcycle fairings is desirable as a mechanism to block the wind and thereby reduce rider fatigue and cold, as well as providing a location to mount equipment such as communication and audio gear, gauges and storage pouches in a position that can be easily viewed and accessed by the rider. This is especially true for long distance trips where the additional gear and reduced rider fatigue enhance the safety and enjoyment of the journey.

It is also desirable to have the ability to remove such a motorcycle fairing for shorter distance and lower speed trips where the rider may prefer to engage the wind. In addition, the rider may prefer the appearance of the motorcycle without the fairing or sometimes with a smaller windshield mounted to the motorcycle. Traditionally, motorcycles and fairings have been designed such that the fairings are permanently mounted leaving the rider with the choice of purchasing a motorcycle with a fairing, purchasing a motorcycle without a fairing, or purchasing both motorcycles.

### SUMMARY OF THE INVENTION

The invention is directed at enabling a motorcycle user to connect and disconnect a fairing to and from the motorcycle using fairing mounting brackets that guide the fairing into and out of a fully engaged position on the motorcycle. Advantageously, the invention enables the user to do so without need for tools, and little fairing-related mounting hardware is left on the motorcycle if the fairing is removed.

In one aspect, the invention envisions an upper and a lower female U shaped docking points oriented generally downward for engaging an upper and a lower circular male docking posts located on a motorcycle on the upper sides of the fork assembly; a rearward facing bracket edge to guide the motorcycle fairing bracket into a secure position by sliding against the upper male docking post and leading into a slotted section which the upper male docking post slides through leading to the female upper U shaped docking points in the brackets; and a lower extremity of the bracket including a substantially wide, generally downward facing opening which acts as a guide by sliding against the lower male docking post during installation, the opening tapering into a slotted section which forms the lower female U shaped docking point for receiving the lower docking post.

### BRIEF DESCRIPTION OF THE DRAWINGS

FIG. 1 is a side view of one implementation of the fairing bracket, in accordance with one embodiment of the invention.

FIGS. 2A and 2B are perspective views of another implementation of the fairing bracket including a locking mechanism, in accordance with another embodiment of the invention.

FIG. 3 is a perspective view of the fairing with clear windshield at top, opaque middle section and guide brackets emanating below.

FIG. 4 is a side view of a guide bracket and the upper and lower male mounting points on the motorcycle in the initial alignment.

FIG. 5 is a side view of a guide bracket and the upper and lower male mounting points on the motorcycle just before the upper male mounting point has slid into the upper slotted section and after the lower male mounting point has engaged the lower wide slotted section.

FIG. 6 is a side view of a guide bracket and the upper and lower male mounting points on the motorcycle after the male mounting points have both fully engaged the U shaped female docking points on the fairing brackets and the latching mechanism has pivoted into the latched position.

FIGS. 7-9 illustrate the design and operation of a locking mechanism affixed to the faring mounting bracket, in accordance with one embodiment of the invention.

FIG. 10 is a side view of yet another embodiment of the present invention.

### DETAILED DESCRIPTION OF EMBODIMENTS OF THE INVENTION

Briefly stated, the invention envisions two fairing mounting brackets attached on either side of the lower portion of a fairing assembly. The brackets engage the motorcycle at the upper portions of the fork assembly via an upper and lower docking post on each side of the motorcycle. The edges of the brackets serve as guide ramps that lead to upper and lower U shaped female docking points in the brackets During attachment, the brackets guide the fairing downward by sliding the guide ramps along the male docking posts on the motorcycle into a position where the upper and lower male docking posts fully engage the upper and lower female docking points of the brackets. A locking mechanism can be used to secure the brackets to the motorcycle when in the fully engaged position.

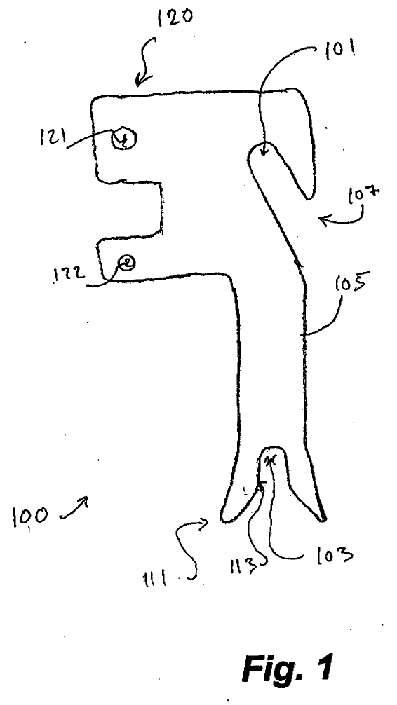

FIG. 1 is a side view of one implementation of the fairing bracket, in accordance with one embodiment of the invention. As illustrated in FIG. 1, the fairing mounting bracket (the ‘bracket’) 100 principally includes an upper docking point 101 and a lower docking point 103. These two docking points are female and generally U shaped. The two docking points (101, 103) are slightly wider than the width of two male docking posts that are mounted on the motorcycle such that the female docking points and the docking posts may nest snugly together.

The bracket also defines a rearward facing guide edge 105. The rearward facing guide 105 leads upward to a slotted section 107 that is, in this embodiment, slightly wider than the width of the upper male docking post on the motorcycle. This slotted section 107 is oriented generally at a downward and slightly rearward angle off of a substantially vertical plane through the upper and lower docking points (101, 103). The upper slot 107 leads ultimately to the upper female docking point 101.

The lower extremity of the bracket 100 contains a significantly wide slotted portion 111 that is oriented generally vertically in line with a vertical plane through the upper and lower docking points (101, 103). This wide lower slot 111 is tapered such that it becomes narrower higher up in the bracket 100. The tapered section leads to a slot 113 higher up in the bracket 100 that is only slightly wider than the width of the lower male docking post on the motorcycle. This narrow slot 113 is oriented generally vertically in line with the vertical plane through the upper and lower docking points (101, 103) and leads ultimately to the lower docking point 103, which is only slightly wider than the width of the lower male docking post on the motorcycle such that the docking points and the docking posts may nest snugly together.

The bracket 100 further includes a fairing attachment portion 120 for attaching the bracket 100 to a fairing. In this particular implementation, the attachment portion 120 includes mounting apertures (121, 122) through which mounting hardware (e.g., bolts, rivets, etc.) can be used to securely affix the bracket 100 to the fairing. It will be apparent that the attachment portion 120 will need to be specially designed to accommodate the particular fairing on which the bracket 100 will be attached, and many different configurations will be necessary and possible.

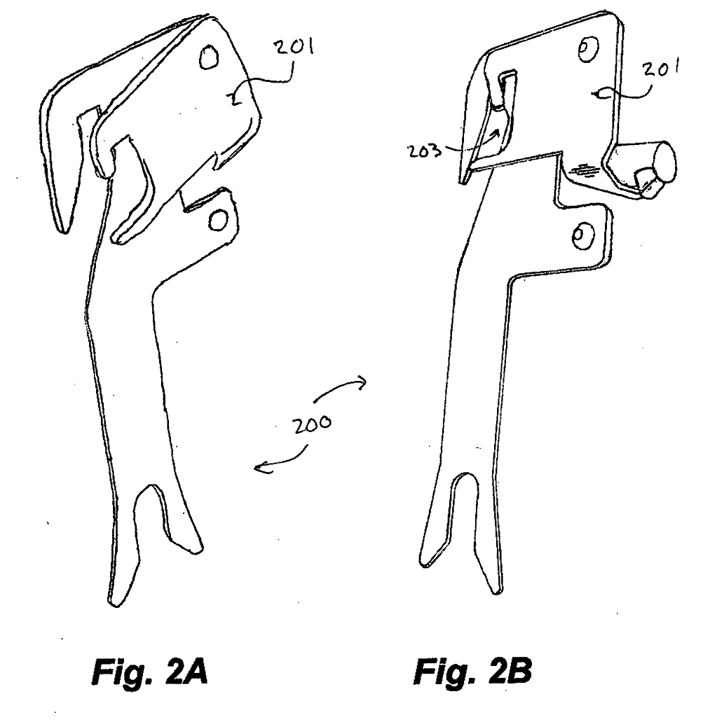

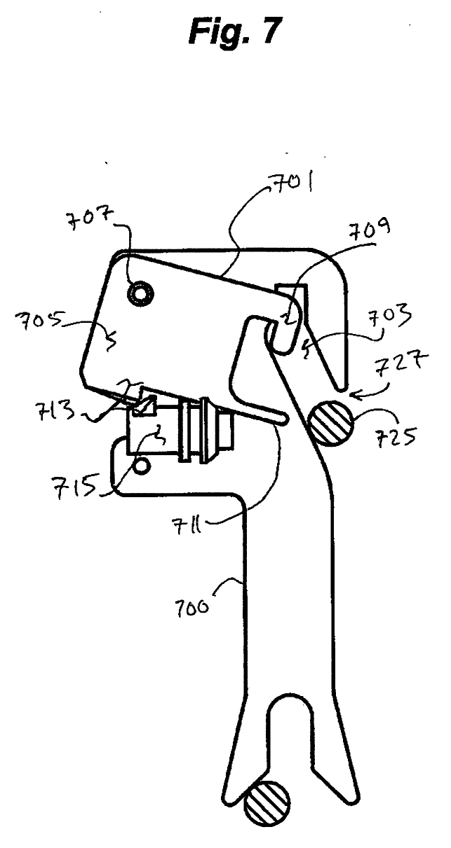

FIGS. 2A and 2B are perspective views of another implementation of the fairing bracket including a locking mechanism, in accordance with another embodiment of the invention. In this implementation, a fairing mounting bracket 200 is provided with substantially the same elements as provided in the embodiment illustrated in FIG. 1. In addition, a locking mechanism 201 is attached to the upper portion of the bracket adjacent to the upper docking point 203. The locking mechanism 201 of this particular implementation is illustrated in greater detail in FIGS. 7-9, and described below.

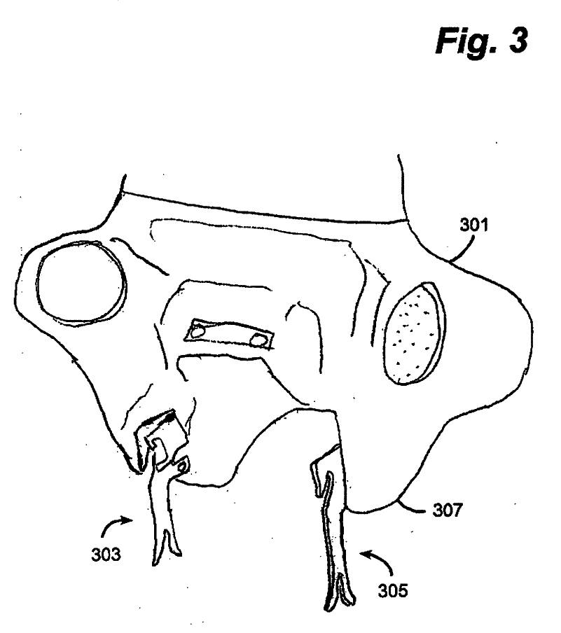

FIG. 3 is a perspective view of a fairing 301 with clear windshield at the top, opaque middle section, and fairing mounting brackets (303, 305) emanating below. In this implementation, the two fairing mounting brackets (303, 305) are attached to the opaque lower portion 307 of the fairing 301 using the mounting locations (121, 122 FIG. 1) of the brackets. It should be noted that the invention is not limited to use only on fairings as illustrated in FIG. 3. Instead, for the purposes of this document, the term “fairing” shall have its broadest possible meaning, and includes any accessory that attaches to the forward part of a motorcycle, regardless of the degree of transparency or opacity of any portion or subportion thereof, and serves to affect the flow of wind on the rider of the motorcycle and/or provides a surface on or in which other accessories might be mounted.

The brackets (303, 305) emanate slightly rearward (meaning toward the rear of the motorcycle if the fairing 301 were attached) and downward (meaning in the direction of gravity) from the lower portion 307 of the fairing 301. The motorcycle (not shown) has four circular male docking posts on the upper sides of the fork assembly, an upper and a lower docking post on each side. As described more fully in the following discussion, the two fairing mounting brackets 303 engage the four male docking posts to securely attach the fairing 301 to the motorcycle.

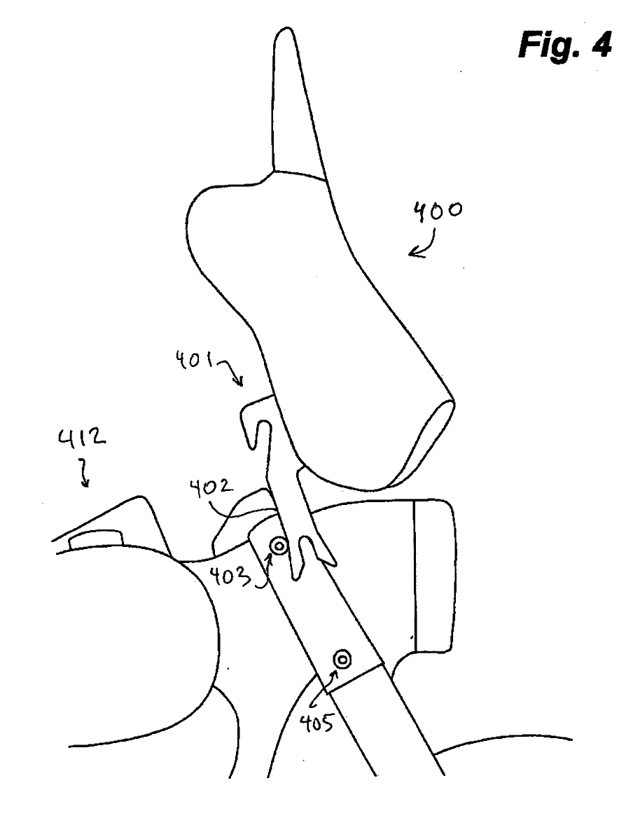

FIGS. 4-6 illustrate the installation of a faring 400 to a motorcycle 412 using one implementation of the invention. The installation will be described here with reference to a single fairing mount as shown in the Figures, but it should be appreciated that the process is performed simultaneously using both fairing mounting brackets.

Referring first to FIG. 4, the installation begins with a user aligning the middle of the rearward facing edge (the guide edge 402) of the fairing bracket 401 against the forward facing edge of the upper circular male docking post 403 on the motorcycle 412. The user then lowers the fairing 400 by sliding the guide edge 402 downwardly against the upper male docking post 403.

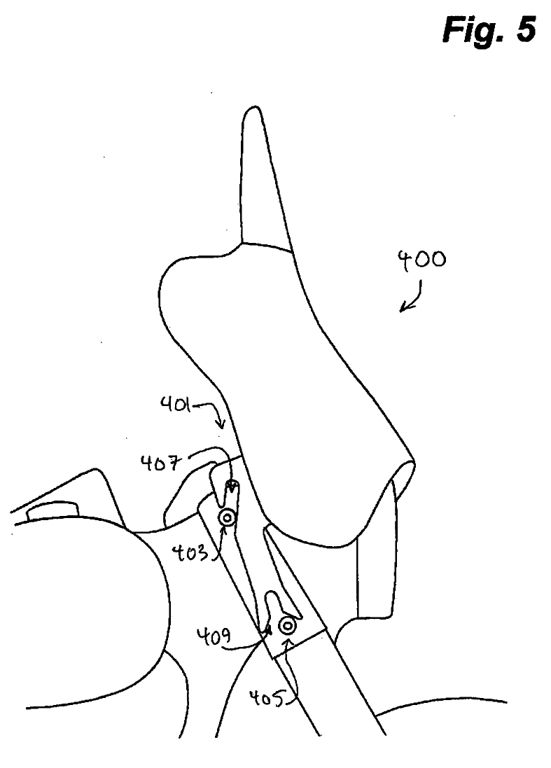

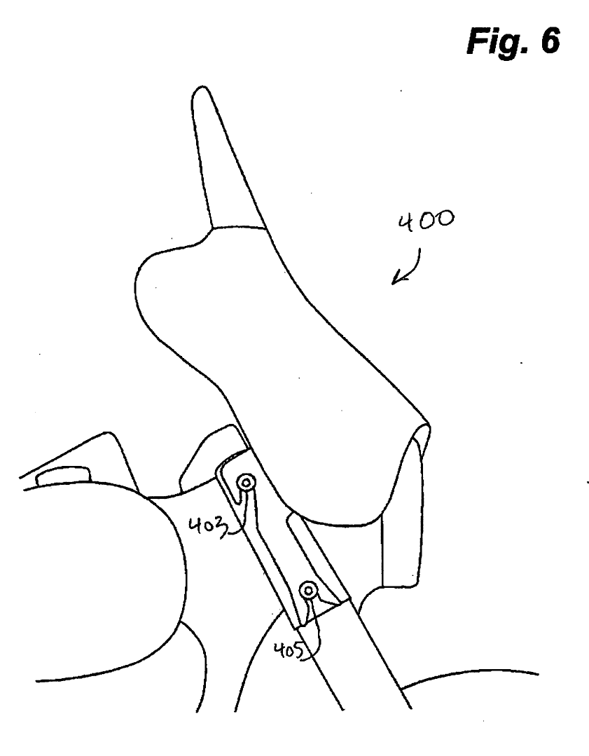

Turning now to FIG. 5, lowering the fairing 400 serves to lead the upper circular male docking post 403 into the slotted area 407 in the upper portion of the fairing mounting bracket 401. Simultaneously the lower circular male docking post 405 on the motorcycle 412 begins to enter the lower wide slotted portion 409 of the fairing mounting bracket 401. The lower slotted portion 409 is sufficiently wide such that considerable fore and aft misalignment of the bracket 401 relative to the lower male docking post 405 is tolerated. As the user lowers the fairing 400 further onto the motorcycle 412 the tapered design of the lower slotted portion 409 guides the lower male docking post 405 into the slotted upper section of the lower slot 409 in the fairing mounting bracket 401. The user then continues to lower the fairing 400 until the upper and lower docking posts (403, 405) are snug within their respective docking points on the fairing mounting bracket 401. Ultimately the upper and lower male docking posts (403, 405) terminate within the upper and lower U shaped female docking points in the fairing bracket (FIG. 6).

From the foregoing, it will be appreciated that after the user initially positions the fairing mounting brackets with the rearward facing guide edge against the upper male docking points on the motorcycle, he/she is able to lower the fairing into place principally by “feel” with only general visual alignment between one of the lower female docking points on the fairing mounting brackets and one of the lower male docking points on the motorcycle as long as the user maintains enough rearward force as the fairing is lowered such that the fairing mounting bracket guide edge stays in continual contact with the upper male docking point on the motorcycle. This is so because the two fairing mounting brackets are oriented in a position parallel to each other, as are the male docking posts on the motorcycle, such that correct fore/aft alignment on one side of the motorcycle will result in correct fore/aft alignment on the other side. This is an important feature and is especially beneficial in case of a significantly large and opaque fairing where it would otherwise be nearly impossible or impractical for the user to visually align both of the lower male docking points on the motorcycle with the lower female docking points on the fairing brackets.

FIGS. 7-9 illustrate the design and operation of a locking mechanism 701 affixed to a faring mounting bracket 700, in accordance with one embodiment of the invention. In this embodiment, the bracket 700 includes a locking mechanism 701 near the upper female docking point 703. The locking mechanism 701 includes a mechanism body 705, a pivot point 707, male docking point engagement arm 709, blocking arm 711, lock engagement arm 713, and spring-bolt type lock 715.

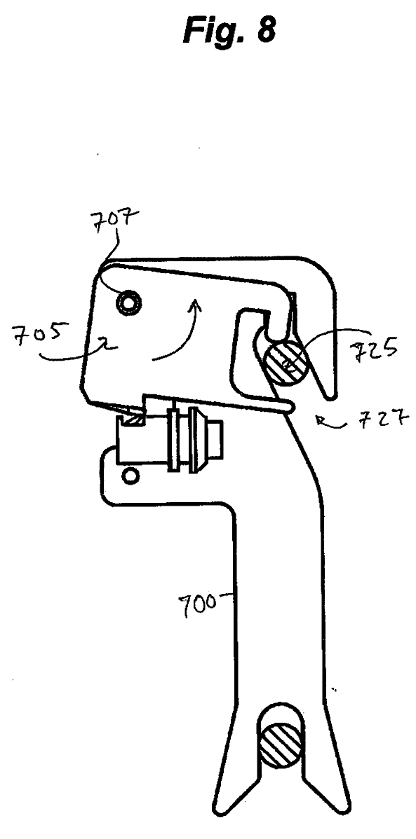

As the upper male docking post 725 moves through the slotted section 727 on the fairing mounting bracket 700 and toward the upper female docking point 703 on the bracket (see FIG. 7) the docking post 725 contacts the docking point engagement arm 709 which extends generally rearward from the upper portion of the mechanism body 705. As the docking post 725 moves through the slotted section 727 (see FIG. 8) it causes the mechanism body 705 to pivot about the pivot point 707.

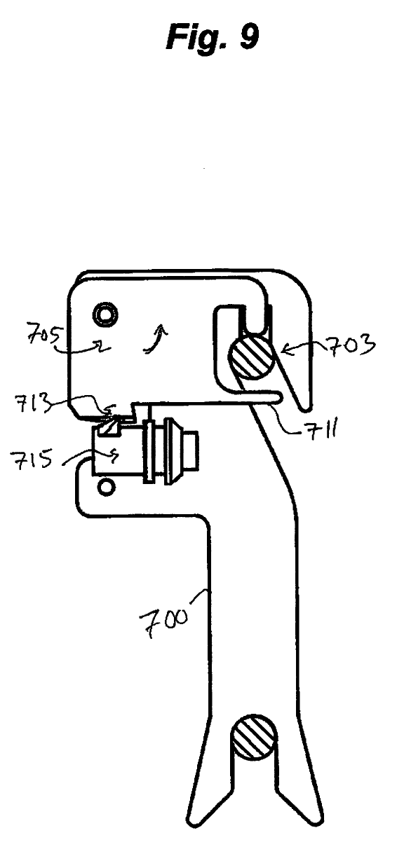

As the docking post 725 moves fully into the female docking point 703 on the bracket 700 (see FIG. 9) the locking mechanism body 705 continues to pivot, thus moving the blocking arm 711 into a position substantially perpendicular to the orientation of the upper slotted section of the fairing mounting bracket 700. As a consequence of the movement of the blocking arm 711, the lock engagement arm 713 contacts a ramped spring loaded bolt on the spring-bolt type lock 715. The lock engagement arm 713 moves past the ramped spring loaded bolt when the male docking post 725 is fully seated in the female U shaped docking point 703. The spring loaded bolt 715, when thus fully extended, effectively restricts the movement of the pivoting locking mechanism 701 and prevents the lock engagement arm 709 from moving rearward or downward. Due to the fact that the blocking arm 711 is positioned perpendicular to the orientation of the upper female docking point slot 727 the male upper docking point 725 is prevented from movement thus effectively locking the bracket 700, and thereby the fairing, onto the motorcycle.

The disengagement of the spring-bolt type lock 715, which depending on its design may be through the turning of a key, pushing of a button, or turning of a knob etc., causes the spring-bolt to retract into its lock body 715. This permits the free movement of the locking mechanism body 705 about its pivot point 707, a movement which could, in one embodiment, be assisted by a return spring. The bracket 700 and thus the fairing will then be freed from the motorcycle when the user lifts upwardly on the fairing assembly while disengaging the spring-bolt type lock 715. The fairing assembly can then be easily removed from the motorcycle.

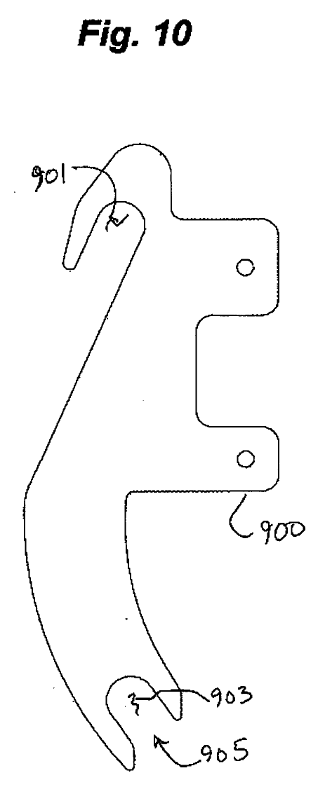

FIG. 10 is a side view of yet another embodiment of the present invention. In this implementation, a bracket 900 includes an upper docking point 901 and a lower docking point 903, in like manner to the implementation illustrated in FIG. 1 and described above. In this implementation however, the lower docking point 903 is defined by a uniform slot 905 that extends slightly upward and angled from the bottom extremity of the bracket 900 toward the lower docking point 903.

The invention is not limited by the several embodiments and implementations described above and illustrated in the Figures. Rather, the invention is limited only by the scope of the appended claims.

What is claimed is:

1. A motorcycle fairing bracket, comprising:
upper and lower female U shaped docking points for engaging an upper and a lower circular male docking posts located on a motorcycle on the upper sides of the fork assembly;
a rearward facing bracket edge to guide the motorcycle fairing bracket into a secure position by sliding against the upper male docking post and leading into a slotted section which the upper male docking post slides through leading to the upper female U shaped docking point in the bracket; and
a lower extremity of the bracket including a lower opening that acts as a guide by sliding against the lower male docking post during installation, the lower opening leading to a slotted section that forms the lower female U shaped docking point for receiving the lower docking post.

2. The motorcycle fairing bracket recited in claim 1, further comprising a wide upper slot which tapers into the upper female U shaped docking point.

3. The motorcycle fairing bracket recited in claim 1, further comprising upper and lower male docking posts that are spaced apart from each other a distance substantially equal to the distance between the upper and lower U shaped female docking points.

4. The motorcycle fairing bracket recited in claim 1, further comprising a locking mechanism for securely attaching the fairing to the motorcycle.

5. The motorcycle fairing bracket recited in claim 1, wherein the lower opening is substantially wide and generally downward facing.

6. The motorcycle fairing bracket recited in claim 1, wherein the lower opening is tapered.

7. The motorcycle fairing bracket recited in claim 1, wherein the lower opening is not tapered.

8. A motorcycle fairing including the motorcycle fairing bracket recited in claim 1.

9. A motorcycle fairing bracket, comprising:
upper and lower docking points for engaging upper and lower docking posts on a motorcycle to detachably secure a fairing to the motorcycle; and
a spring loaded locking mechanism for securing the fairing to the motorcycle.

10. The motorcycle fairing bracket recited in claim 9, wherein the spring-loaded locking mechanism is configured to engage upon a rotation of a locking body about a pivot point.

11. The motorcycle fairing bracket recited in claim 10, wherein the rotation is incidental to installing the fairing on the motorcycle.

12. A motorcycle fairing including the motorcycle fairing bracket recited in claim 11.
